(19) United States
(12) Patent Application Publication
(10) Pub. No.: US 2025/0053928 A1
(43) Pub. Date: Feb. 13, 2025

(54) SYSTEMS AND METHODS FOR PROVIDING TRANSPARENT ACTION BASED REWARDS VIA DECENTRALIZED COMPUTING NETWORK TRIGGERS

(71) Applicant: Talentpair, Inc., Boise, ID (US)

(72) Inventors: Dustin Colter, Boise, ID (US); Joseph Richard Kosakowski, Boise, ID (US)

(21) Appl. No.: 18/617,377

(22) Filed: Mar. 26, 2024

Related U.S. Application Data
(60) Provisional application No. 63/492,991, filed on Mar. 29, 2023.

(51) Int. Cl. G06Q 10/1053

(52) U.S. Cl. CPC G06Q 10/1053

(57) ABSTRACT

Introduced herein is a web architecture (e.g., a hiring ecosystem) that addresses the limitations and issues associated with traditional/existing recruiting platforms using smart contracts, artificial intelligence, and other blockchain methodologies to provide a transparent system of triggering action induced distribution of rewards. The web architecture integrates smart contract elements with artificial intelligence command sets and outputs. For instance, by storing data associated with candidates, recruiters, job postings, and smart contracts “on chain,” and providing an optimized triggering of a distribution of rewards for contributions on the hiring architecture, individuals may be provided with an automatic distribution of rewards in response to a given action or contribution performed within the ecosystem.

### CROSS-REFERENCE TO RELATED APPLICATIONS

The present application claims benefit of priority to U.S. Provisional Patent Application No. 63/492,991, filed Mar. 29, 2023, the disclosure of which is incorporated herein by reference in their entirety.

### BACKGROUND

Connecting talented individuals to job postings is often a difficult, time consuming, exclusive, and inefficient task. For example, although talented individuals are constantly signing up for differing platforms to find suitable jobs, oftentimes algorithms designed by such platforms filter out relevant opportunities based on the profile of the user. For instance, due to the opacity of the algorithms governing a given platform, users are often at a loss on how to connect to a given job, what rewards a user may be provided for connecting an individual to a job, what actions may affect their profile, or other hiring-related actions. Furthermore, existing hiring platforms may sell user data to other companies without the user's consent, which victimizes the user as the hiring platform may benefit from the user's data while having no regard as to whether the user benefits from utilizing the platform (e.g., by being connected to a job). This drives frustration and leads to individuals leaving the platform, or worse yet, other individuals receiving rewards for actions of another, causing a poor user experience. These and other drawbacks exist.

### BRIEF DESCRIPTION OF THE DRAWINGS

FIG. 1 shows a set of blocks cryptographically linked to form a blockchain, in accordance with some implementations of the present technology.

FIG. 2 illustrates an Ethereum block structure, in some implementations of the present technology.

FIG. 3 illustrates an example of a data block that stores data as an asset, in accordance with some implementations of the present technology.

FIG. 4 shows a smart contract block, in accordance with some implementations of the present technology.

FIG. 5 shows a smart contract-based ecosystem, in accordance with some implementations of the present technology.

FIG. 6 shows a set of nodes in relation to action-based rewards, in accordance with some implementations of the present technology.

FIG. 7 shows an illustrative flow diagram of action-based rewards, in accordance with some implementations of the present technology.

FIG. 8 shows a system architecture of the disclosed system, in accordance with some implementations of the present technology.

FIG. 9 shows an illustrative table indicating actions and reward percentages, in accordance with some implementations of the present technology.

FIG. 10 shows a block diagram illustrating an example of a processing system in which at least some operations described herein can be implemented.

The attached Appendices illustrate further details of the disclosed system in some implementations.

In the drawings, some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the specific implementations described. On the contrary, the technology is intended to cover all modifications, equivalents, and alternatives falling within the scope of the technology as defined by the appended claims.

### DETAILED DESCRIPTION

Advances in technology have resulted in connecting job candidates to a wide variety of skilled professions quickly. For example, recruiting platforms often involve recruiters that search for qualified candidates for placement at companies to fill a particular job. As a reward for a recruiter's efforts in placing a candidate, the platform, agencies, or even the companies themselves may pay the recruiter for successful placement of a candidate. However, these recruiting platforms often end here, lacking any opportunity for a recruiter to “move up” in responsibilities and preventing recruiters from receiving additional funds for placing an exceptional candidate based on the candidate's performance at the company.

Additionally, existing recruiting platforms are opaque (e.g., not transparent) which may lead to certain candidates being prioritized over other candidates, as well as some recruiters receiving more funds/rewards for similar candidates recruited for a particular job. This in and of itself leads to a poor user experience as the opaqueness of such platforms tend to drive away individuals frustrated by the lack of equality. Furthermore, such recruiting platforms have no mechanism to optimize the distribution of funds/rewards. For instance, due to the opaqueness involved and the operational constraints of a centralized recruiting platform, funds/rewards may fail to be distributed or accounted for altogether. Without a mechanism to automatically and transparently distribute appropriate funds/rewards for respective contributions one may perform on the platform, talented recruiters and candidates may be driven away from the platform due to the poor user experience involved.

Moreover, such recruiting platforms often employ outdated methods of connecting candidates to differing job postings. For example, recruiters on the platform may simply spam thousands of candidates at once to fulfill a job posting to increase the probability of selecting a candidate for hire to simply obtain funds or other rewards associated with placing the candidate. However, this may lead to an increased amount of time connecting talented candidates to a job posting as the recruiter must parse through the plethora of candidates who indicate their preference for the job, further leading to a poor user experience and an increase of wasted computing memory and processing resources. Existing recruiting platforms must also continually verify candidate, agency, and recruiter data upon each job posting, further leading to an increased amount of computing network traffic as well an increased amount of computer processing and memory resources as each verification request must be transmitted over a network, verified, and subsequently returned with a verified status update.

Introduced herein is a hiring architecture (e.g., a hiring ecosystem) that addresses the limitations and issues associated with traditional/existing recruiting platforms using smart contracts, artificial intelligence, and other blockchain methodologies to provide a transparent optimized system of triggering action induced distribution of rewards. For instance, by storing data associated with candidates, recruiters, job postings, and smart contracts “on chain,” and providing an optimized triggering of a distribution of rewards for contributions on the hiring architecture, individuals may be provided with an automatic distribution of rewards in response to a given action or contribution performed within the ecosystem. By doing so, the system may improve the user experience, provide data transparency, and reduce the amount of wasted computer processing and memory resources caused by manual verification of each contribution. Additionally, users may also experience a clear insight as to a hiring process, decreased job placement timelines, and equality amongst users within the hiring ecosystem.

The hiring architecture (e.g., hiring ecosystem) can include a set of abiotic actors or actions, and biotic actors. Abiotic actors or actions may be non-living (e.g., non-human based) parts/roles of the ecosystem. As an example, abiotic actors may be Artificial Intelligence models or smart contracts, and abiotic actions may be candidate matching (e.g., to a job posting), submittals (e.g., submissions of a job posting), offers (e.g., offer for a job), or other actions, in accordance with some implementations of the present technology. Biotic actors may be living (e.g., human based) parts/roles of the ecosystem. For example, biotic actors may be candidates, hiring managers, and growth partners. As users interact with the hiring architecture, users may be assigned as a biotic actor based on one or more qualifications the user possesses. The abiotic and biotic actors and actions may work together, as governed by smart contracts, to place qualified candidates to one or more jobs.

The hiring architecture achieves transparent job placement with optimized distribution of rewards for respective contributions by using at least one smart contract as the governing body of the hiring architecture. The term “smart contract,” as used herein, may refer to a self-executing contract with the terms of an agreement between one or more parties that are codified (e.g., written into lines of code). The smart contract may be stored on a blockchain and may execute one or more operations upon completion of one or more actions. The agreement may be an implicit or explicit agreement, such as when a user signs up to become a given actor, and may accept the terms of the agreement (e.g., the rules, regulations, or other information) as defined in the smart contract. As the smart contract is stored on the blockchain, due to the immutable nature of the blockchain, users (e.g., actors) are provided with the utmost transparency regarding actions associated with the hiring architecture. Furthermore, users are also provided with an automatic distribution of funds for given contributions they make within the hiring architecture due to the self-executing nature of the smart contract. In this way, the user experience is improved as data transparency and the automatic triggering of actions (e.g., distribution of funds) are enabled via the smart contract.

The hiring architecture also achieves a decreased amount of computer network traffic. For example, as users are added to the hiring architecture as actors, the hiring architecture may generate an NFT indicating the user's role, qualifications, certifications, and other user data. The term “NFT” (or non-fungible token), as used herein, may refer to a unique digital item that cannot be copied or reproduced without the owner's knowledge and consent. For example, an NFT may represent a user profile, art, files, or other digital content that is immutable (e.g., cannot be altered). Due to the immutable nature of an NFT, when storing user data to/as an NFT, the NFT serves as a digital certificate of authenticity. Each user (e.g., actor) may be associated with an NFT, and the hiring architecture need only verify the user data of the NFT once (e.g., as once minted/created, the NFT data cannot change). Therefore, when the NFT is created and stored on the blockchain, the NFT becomes a permanent, transparent, representation of the actor and need not be verified again. For example, in some implementations, when the NFT is minted (e.g., created), the NFT may be associated with immutable data and mutable data. The immutable data may be a token identifier (e.g., token_ID, a universal unique identifier, etc.) or other immutable data (e.g., hash values of the block to which the NFT is associated with, the name of a user, etc.). The mutable data may be stored as metadata associated with the NFT, such as qualifications, certifications, current employment information, past employment information, a user's contact information, or other user information. In some implementations, the metadata of the NFT may include a link to a uniform resource identifier (URI) or uniform resource locator (URL) pointing to the mutable data, enabling the mutable data to be stored off-chain in a permissioned database (e.g., where only certain, permissioned actors have access to such information) to preserve data security of Personally Identifiable Information (PII). When the NFT is verified (e.g., by the hiring architecture, by a growth partner, by a hiring manager, or by a system administrator), subsequent reverification of the user is not needed as the NFT is a verified representation of the user. As such, the NFT may be used in the future within the system to confirm/verify the identity of the actor to perform one or more actions within the hiring architecture without verifying the data associated with the NFT each time an action is to be performed, thereby reducing the amount of computer network traffic.

In some implementations, the hiring architecture may generate an Non Transferable Token (NTT) associated with each user (e.g., actor). For instance, a NTT may be a SoulBound token (SBT) enabling a non-transferable identity of the user to be established. That is, as opposed to an NFT which is transferrable (e.g., can be transferred to one user to another, bought, sold, etc.), an NNT is not transferrable and cannot be transferred to another user. Using NNTs is advantageous as, due to their nontransferable nature, NNTs may reduce the chance of identity theft when utilizing the hiring architecture (or other blockchain-based architecture). In some implementations, the NNT may store the same (or similar data) as the NFT as described above, with the additional advantage of being non-transferrable. As such, and as used herein, NNT's may be used in lieu of NFT's, in accordance with some implementations of the present technology.

The hiring architecture also provides actors to change a given role (e.g., state) when certain qualifications, actions, or other criteria are met seamlessly without re-verification. For example, as each actor is associated with an NFT/NTT identifying the actor, each NFT/NNT may include metadata indicating the user's state or role. For example, the role (or state) may indicate whether the user is a candidate, growth partner, or hiring manager. By performing actions at the right time in accordance with a given methodology as defined in the smart contract, users may change their role. For example, the system may update metadata associated with the NFT to update the user's role. In this way, although the original data stored within the NFT is immutable, users may nonetheless be updated to differing states via the metadata, forgoing re-verification and minting of a new NFT, thereby reducing the amount of computer processing and memory resources.

In some implementations, the hiring architecture may use a set of role-based NNTs to indicate an update to a user's state or role. For example, as a user (e.g., actor) transitions from one role/state to another, a new NNT may be generated indicating the user's updated role. Such NNTs may be linked together (e.g., via one or more addresses, URIs, URLs, etc.) to create a set of NNTs, each indicating a sate/role of the user (e.g., past and present). As each NNT is associated with the user (e.g., by a token identifier or other verified value), each NNT may be linked to an identity of a user, thereby preserving users identity as the user transitions from one role to another.

In the following description, for the purposes of explanation, numerous specific details are set forth in order to provide a thorough understanding of implementations of the present technology. It will be apparent, however, to one skilled in the art that implementation of the present technology can be practiced without some of these specific details.

The phrases “in some implementations,” “in several implementations,” “according to some implementations,” “in the implementations shown,” “in other implementations,” and the like generally mean the specific feature, structure, or characteristic following the phrase is included in at least one implementation of the present technology and can be included in more than one implementation. In addition, such phrases do not necessarily refer to the same implementations or different implementations.

### Blockchain Technology Overview

Blockchain technology (or distributed ledger technology) generally refers to a growing list of digital records (e.g., blocks) that are connected by a cryptographic hash of the previous block. Each block may further include a timestamp and other data related to an action that has occurred. The timestamp may indicate (or otherwise prove) that data included in the block was present or otherwise created at that moment in time. Additionally, each block includes a hash value that represents a hash of the information included in the previous block. As each block includes this hash, when other blocks are added to the blockchain, subsequently added blocks may inherently include information of the previous blocks via the hash. This is advantageous as verifying the validity of a newly created block need not rely on verifying each subsequent block, but merely verifying that the hash of the previous block is indeed valid. As such, blockchains are resistant to modification because any alteration to data in a block requires alteration of each previously recorded block.

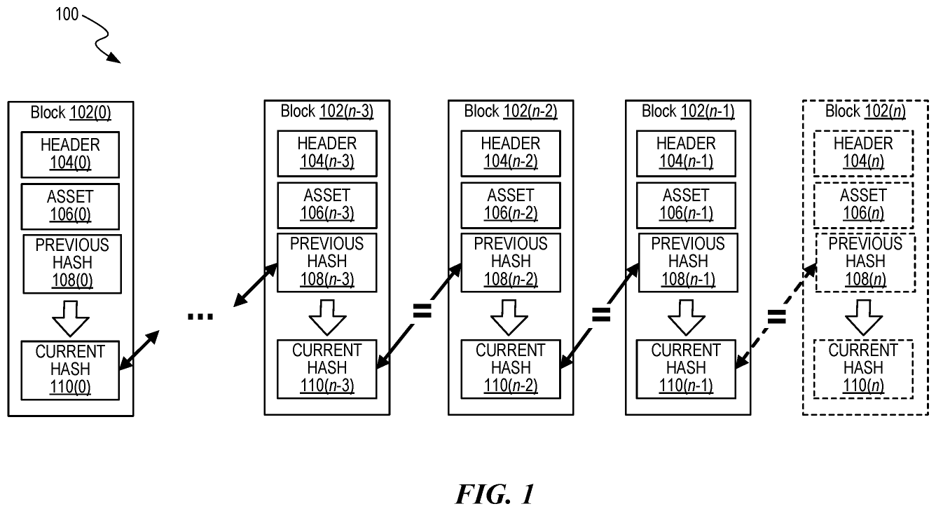

FIG. 1 shows a set of blocks cryptographically linked to form a blockchain, in accordance with some implementations of the present technology.

For example, FIG. 1 shows a set of n blocks 102 that are cryptographically linked to form a blockchain 100. Each block 102 includes header information 104, an asset 106, a previous hash 108, and a current hash 110. When the blocks are linked together (e.g., via their hash values), the blocks form a chain of blocks (e.g., a blockchain) where the current hash 110 of a previous block is the previous hash 108 of the current block. For instance, new block 102(n) includes previous hash 108(n), where previous hash 108(n) is the current hash 110(n−1) of previous block 102(n−1). It should be noted, that FIG. 1 also shows genesis block 100(0). The genesis block 100(0) is the first block minted (e.g., created) on the given blockchain. In some implementations, for a respective blockchain, the genesis block 102(0) may store its previous hash 108 as its current hash 110. In other implementations, the genesis block 102 may not store (or not include) a previous hash 108 as it is the first block in the block chain.

Copies of the blockchain 100 may be stored on multiple computing devices. For example, each computing device may represent a node. Each node may be communicatively coupled to interact with one another to cooperate as a peer-to-peer distributed computing network to implement the blockchain 100 as a distributed ledger. That is, each node may store a copy of the blockchain 100 (or a portion thereof) to increase the integrity of the data stored on the blockchain 100. To further increase the integrity of the data stored on the blockchain 100 (e.g., the blockchain itself), a consensus protocol may govern the addition of blocks to the blockchain 100. For instance, a consensus protocol may act as a validation mechanism for validating new blocks. As an example, a consensus protocol may be a proof of work, proof of stake, or other consensus protocol. When a new block 102(n) is added to the blockchain 100, the consensus protocol may be triggered, where the new block 102(n) is broadcasted to each node. The new block 102(n) may be stored to local copies of the blockchain 100 on each node, and each node may validate the new block 102(n) (e.g., via the consensus protocol, the previous hash 108(n), or other validation mechanism). In this way, the blockchain 100 is secure as any unauthorized modifications to the blockchain 100 may require collusion of a majority of nodes (e.g., 50.0001%, 51%, 52%, etc.) to validate the new node 102(n).

In some implementations, with respect to the present technology, the blockchain 100 may be used to store data. For example, each block 102 in blockchain 100 includes asset 106. The asset 106 may store any data, such as files, smart contracts, images, text, transactions, resumes, user profile information, personal information, non-fungible tokens (NFT's), or other information. For example, to provide a secure hiring architecture, the system may store user information, such as a resume, qualifications, certifications, statuses, names, contact information, validation information, or other information as asset 106, in accordance with one or more implementations of the present technology.

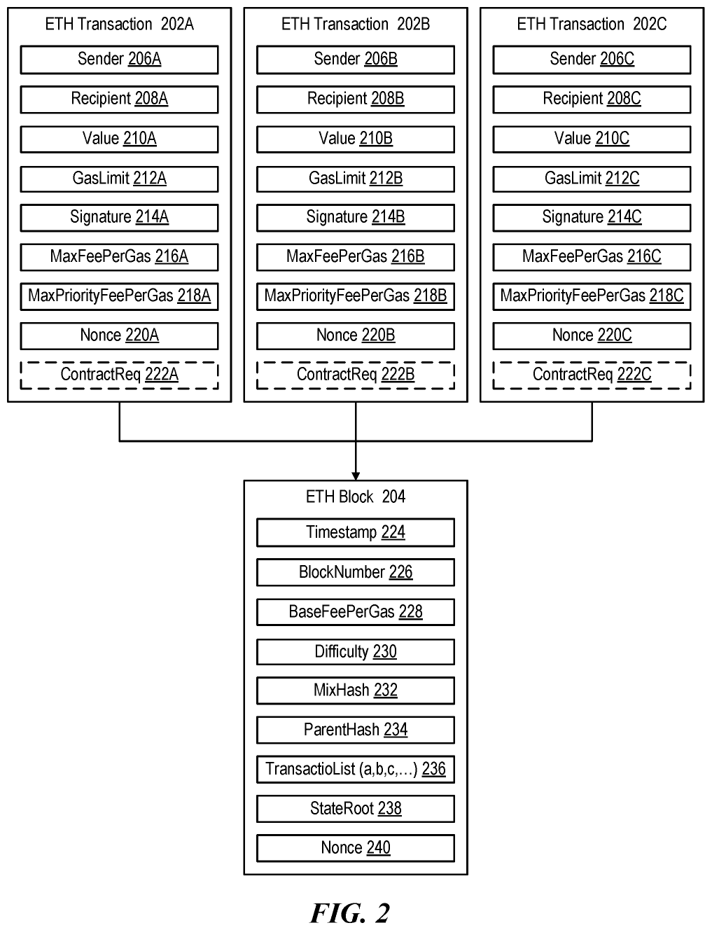

FIG. 2 illustrates an Ethereum block structure, in some implementations of the present technology. For example, Ethereum is a blockchain structure where each transaction stores a set of information to describe a given transaction, and therefore, each block stores a set of information. In the Ethereum block structure, there can be multiple transactions stored in each Ethereum block. For example, in some implementations, the information stored in Ethereum transactions 202a-202c are each included in Ethereum block 204. Each Ethereum transaction 202 may include a sender 206, a recipient 208, a value 210, a gas limit 212, a signature 214, a max fee per gas 216, a max priority fee per gas 218, a nonce 220, and contract requirements 222. In this example, the information stored in Ethereum transactions 202a-202c are then bundled up and Ethereum block 204 is created. The Ethereum block 204 includes a defined set of fields, each of which adhere to a given data structure (e.g., as defined by the Ethereum blockchain). Ethereum block 204 may include a timestamp 225, a block number 226, a base fee per gas 228, a difficulty 230, a mix hash 232, a parent hash 234, a state root 238, and a nonce 240. The Ethereum block 204 also comprises a list of transactions 236 comprised of the transaction information of Ethereum transactions 202a-202c.

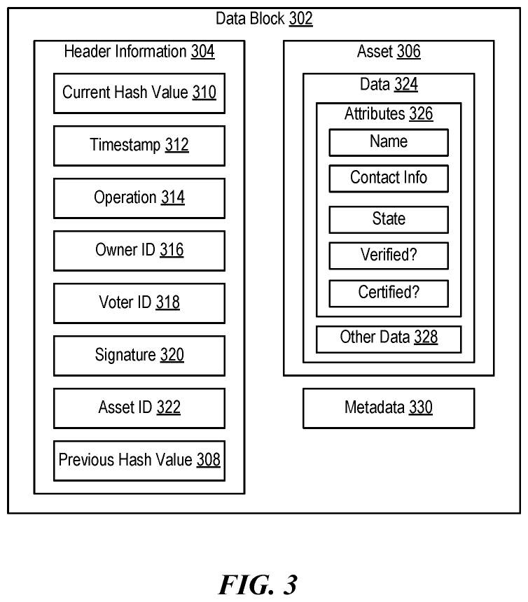

FIG. 3 illustrates an example of a data block that stores data as an asset, in accordance with some implementations of the present technology. For example, each Ethereum block may store data as the asset or a smart contract as the asset. In particular, data block 302 may store data such as header information 304, asset 306, and metadata 330. For instance, header information 304 may include current hash value 310 (e.g., the current hash value of data block 302, timestamp 312 (e.g., the time at which the block was created/added to the blockchain), operation 314 (e.g., an instruction indicating a nature of the block), owner ID 316 (e.g., a set of available addresses that uniquely identify owners of the block), voter ID 318 (e.g., identifiers identifying the nodes that verified the block), signature 320 (e.g., a digital signature enabling others to verify the block's integrity), asset ID 322 (e.g., an identifier associated with the asset 306, a location of where the asset 306 is stored), and a previous hash value 308 (e.g., indicating the previous hash of a previous block to which the current block is connected to on the blockchain).

Additionally, the data block 302 may store asset 306, which may include data 324, and other data 328. For example, asset 306 may include information related to the given asset to which the data block stores information of. In accordance with some implementations of the present technology, the asset can be related to a given user of the hiring architecture, and may include data 324, such as attributes 326. Attributes 326 can indicate information such as the name, contact information, state, verification status, certification status, or other information related to a user, a user profile of the user, or other information. Other data 328 may indicate other information, such as qualifications of a user, job histories of a user, or other information. In some implementations, data 324 (or alternatively, asset 306) may be a NFT of a user of the hiring architecture/ecosystem indicating attributes 326 or other data 328. Data block 302 may additionally include metadata 330, which may indicate information about the asset 306. For instance, the metadata 330 may indicate source related to the asset. For example, the source may be an Internet Protocol address of where the asset is located, a computing device the asset is stored on, or other information related to the asset 306.

In some implementations, the data block 302 may represent one or more data tokens. For instance, in some implementations, to enable one or more of the smart contracts disclosed herein to perform one or more functionalities or operations (e.g., provide transparent action based rewards), the system may use one or more data tokens. Such data tokens may represent the foundational data to which the smart contract interacts with to perform one or more functionalities or operations and may be referred to as “Pillar Data.” The Pillar Data may comprise a number of first party, proprietary, domain specific, data tokens (e.g., 1 million, 2 million, . . . , 5 million, . . . , 10 million, etc.) which may indicate (i) user data, (ii) system data, (iii) event-related data, or (iv) other data, in accordance with one or more implementations of the present technology. The smart contract(s) disclosed herein may use the Pillar Data (e.g., data tokens) to enable the collection, storage, and execution of one or more functionalities or operations (e.g., providing transparent action based awards).

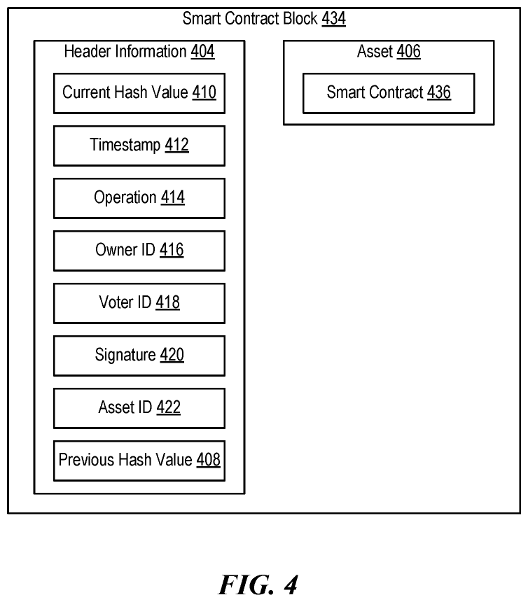

FIG. 4 shows a smart contract block, in accordance with some implementations of the present technology. For example, as discussed above, smart contracts may also be stored on the blockchain. In accordance with some implementations of the present technology, the hiring architecture may store smart contracts on the blockchain that govern the hiring architecture (e.g., actions that users of various states/roles may accomplish, automatic triggering of disbursements of funds for actions related to actions of the users, or other rules/regulations associated with the hiring architecture). For instance, similar to header information 304 of data block 302, smart contract block 434 may also include header information 404. In some implementations, header information 404, current hash value 410, timestamp 412, operation 414, owner ID 416, voter ID 418, signature 420, asset ID 422, and previous hash value 408 may be the same or similar to corresponding information included in header information 304 of data block 302 (FIG. 3). Additionally, such information may function the same or similar to header information 304 of data block described above. The difference between data block 302 and smart contract block 434, however, is the fact that smart contract block 434 stored a smart contract 436 as the asset 406. For example, the smart contract 436 may act as a set of rules (e.g., a governing entity) that may enable one or more actions to be performed, trigger one or more actions to automatically occur, or prevent one or more actions from being performed.

The smart contract 436 may include information related to terms of an agreement or contract, written into lines of code, that may be self-executing based on one or more triggers. For instance, the smart contract 436 may include one or more internal or external functions that interact within the smart contract 436, or outside of the smart contract 436, respectively. Internal functions may include methods that execute within the smart contract 436, such as accessing local state variables, obtaining values from an input data set, converting data from an input data set, or other internal functions. External functions may be methods that may interact with the smart contract 436 outside of the blockchain/smart contract. For example, external functions may obtain information from outside of the blockchain, such as from a centralized database, computing system, or the Internet, or may execute a function that outputs data from the smart contract 436 outside of the blockchain.

The smart contract 436 may additionally include one or more conditions that trigger the execution of the smart contract 436 (or one or more functions of the smart contract 436). For instance, the smart contract 436 may include conditions for monitoring for particular events (e.g., a time, an input data source, an action, etc.) via one or more listening functions of the smart contract. When one or more conditions are met, the smart contract may execute (or execute a set of functions therein), to provide an output. The output may be any output as defined in the smart contract. For example, with respect to some implementations of the present technology, when a candidate for a job is hired at a company, the smart contract may execute, and a growth partner and the hiring manager may each automatically receive a percentage of funds/rewards in one or more accounts (e.g., wallets, digital wallets, cryptocurrency wallets, custodial wallets, non-custodial wallets, digital asset wallets, etc.) associated with the growth partner and the hiring manager, as defined within the smart contract. As another example, upon a candidate signing up for a particular service within the hiring architecture, the smart contract may listen (e.g., through one or more event streams) for the event, and once the condition is satisfied (e.g., the candidate signs up for a service), the smart contract may execute and provide a given percentage of funds to the candidate (or to an account associated with the candidate thereof). As such, the smart contract may automatically be triggered based on one or more actions to provide transparent contributions to respective users of the hiring architecture.

### Hiring Ecosystem

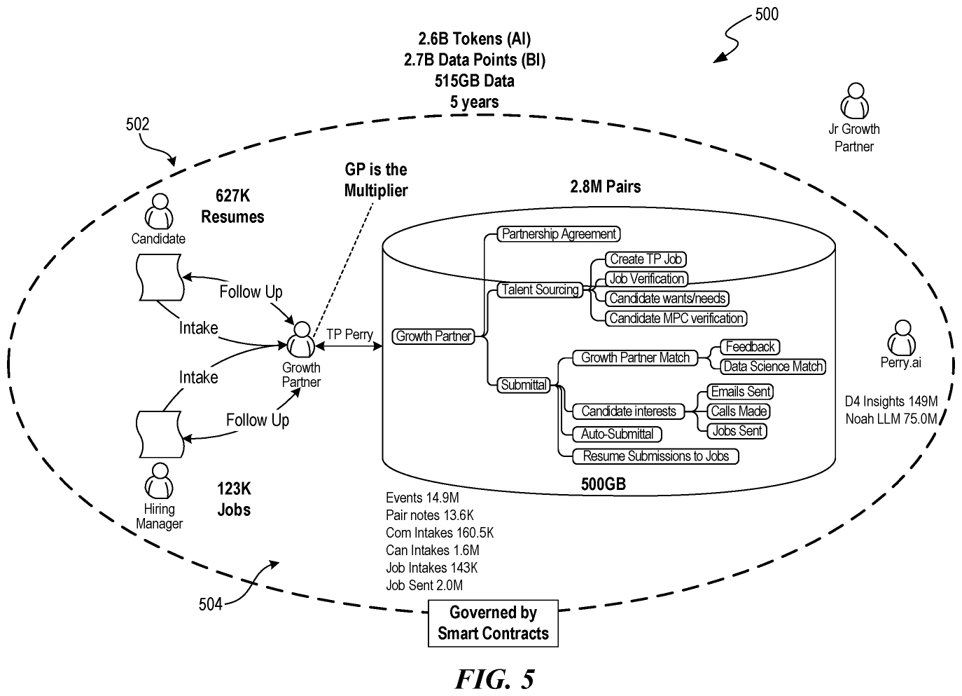

FIG. 5 shows a hiring ecosystem, in accordance with one or more implementations of the present technology. For example, hiring ecosystem 500 includes external components 502 and internal components 504. External components 502 may include actors that are unvalidated with respect to the hiring ecosystem 500. As an example, external components 502 may include actors such as Jr. Growth Partners that are associated with qualities that are similar to a Growth Partner, however are unable to perform one or more actions within the hiring ecosystem 500. Internal components 504 may include validated (e.g., verified) actors with respect to the hiring ecosystem 500. As an example, internal components 504 may include actors such as candidates, hiring managers, growth partners, Perry.ai, or other actors, in accordance with one or more implementations of the present technology.

The internal components of the hiring ecosystem 500 can be governed by smart contracts. For example, as discussed above, the blockchain may store one or more smart contracts governing interactions (e.g., actions) that actors within the hiring ecosystem 500 may perform. Such actions may include candidate invite, candidate intake & onboarding, company invite, company onboarding, job creation, job onboarding, job sends, candidate submit, post-match candidate follow up, scheduling, follow up/feedback, closing/negotiations, placement complete follow up, job description build by TP, candidate profile verified/partial complete, or other actions.

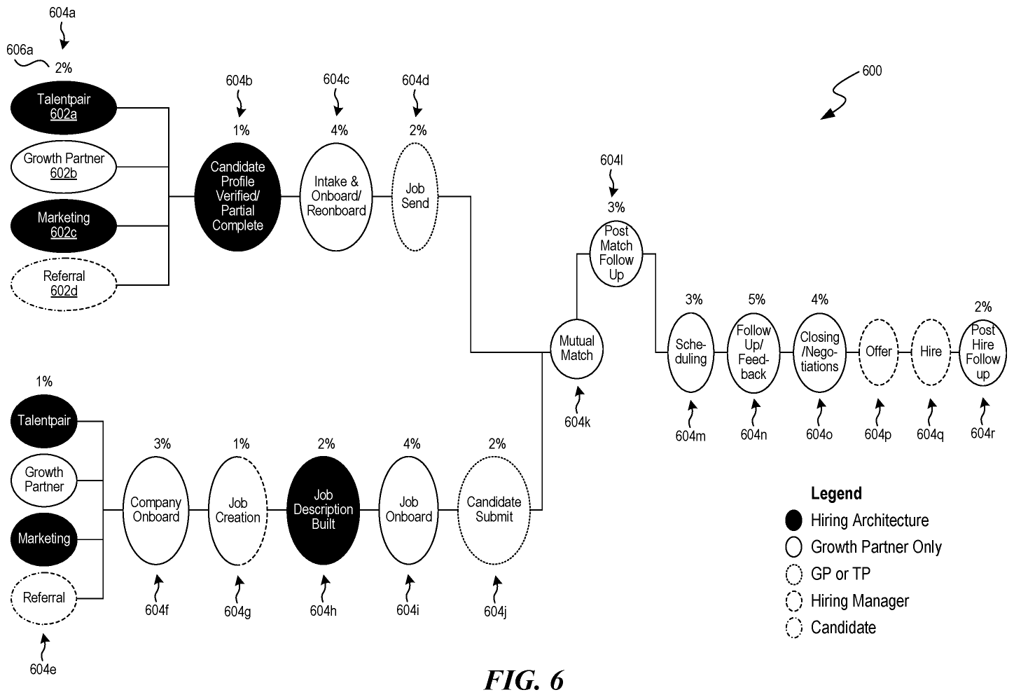

FIG. 6 shows a set of nodes in relation to action based rewards, in accordance with some implementations of the present technology. As referred to herein, a contribution may be an actor's contribution to the hiring ecosystem/architecture. Actors may receive a reward for each action (e.g., contribution) to the hiring ecosystem/architecture. For instance, smart contract node diagram 600 may represent nodes 602 (e.g., nodes 602a-602d), actions 604a-604r) and the respective rewards 606a that are each associated with one another. In some implementations, nodes 602 may represent respective actors (e.g., abiotic or biotic actors). It should be noted, that FIG. 6 is merely exemplary and that other nodes, actions, and contributions may exist. Furthermore, it should be noted that although action 604b-604r does not include labeled nodes (e.g., similar to 602a-602d) or rewards (e.g., similar to 606a), that each of actions 604b-604r can include particular nodes/rewards.

As shown in FIG. 6, each node (e.g., nodes 602) may be associated with a given action (e.g., job creation, follow up, post-match, etc.) and a given reward. For example, with respect to third action 604c, a growth partner node (e.g., growth partner actor) may be associated with a 4% reward with respect to an “intake and onboarding/re-onboard” action. To clarify, as discussed above, users (e.g., actors) may each receive a given amount of funds/rewards (e.g., cryptocurrency, tokens, other digital assets, fiat cash, or other currency) with respect to a particular contribution that the user/actor makes within the hiring ecosystem. FIG. 6 shows various combinations of actors, actions, and rewards that may be received (e.g., as shown as a percent, although fixed amounts can also exist). Where the rewards are shown as percent, the rewards may be received as a percentage of a base value when a user (e.g., actor) completes the right action at the right time as governed by the smart contract. For example, the base value may be a predetermined value (e.g., a fixed value governed by the smart contract) or a dynamic value (e.g., in relation to the amount of funds, cryptocurrency, fiat cash, or other digital assets used with the hiring architecture, such as via sign up fees, matching fees, company onboarding fees, received payment for placing a candidate to a job, etc.). Additionally, it should be noted, that although certain percentages or other values of funds/rewards may be shown or explained, that other percentages/values of funds/rewards may also exist, in accordance with some implementations of the present technology.

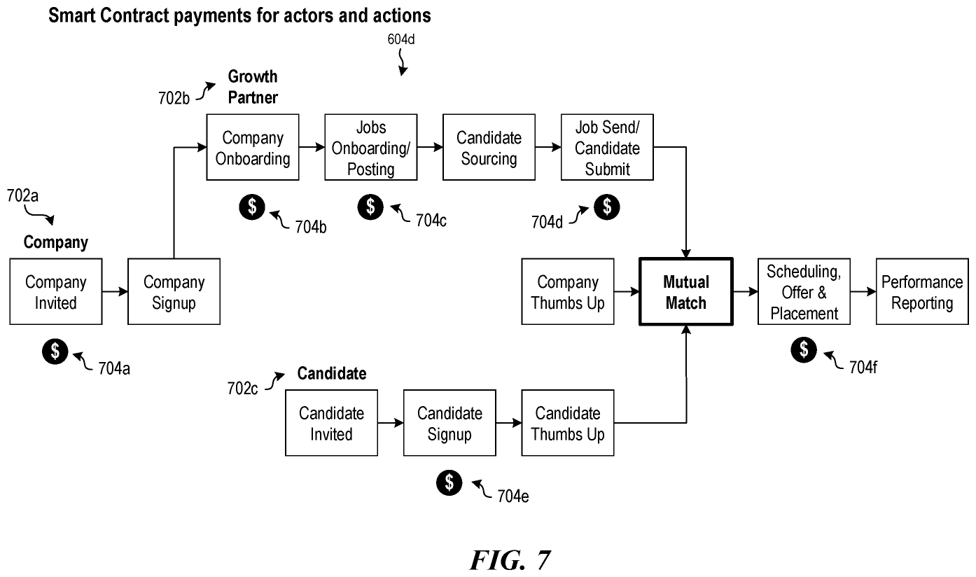

FIG. 7 shows an illustrative flow diagram of action based rewards, in accordance with some implementations of the present technology. In accordance with one or more implementations of the present technology, actors may receive rewards for performing an action at a given time within the hiring ecosystem/architecture. For instance, flow diagram 700 shows an exemplary flow diagram of actors 702 (e.g., 702a-702c) performing the right action at the right time to receive a reward 704 (e.g., 704a-704f) for their contribution as governed by the smart contract (which will be explained later). Each block of flow diagram 700 indicates a respective action that occurs within the hiring ecosystem/architecture. For instance, the actions may include a company invited, company sign up, company onboarding, jobs onboarding/posting, candidate sourcing, job send/candidate submit, candidate invited, candidate signup, candidate thumbs up, company thumbs up, mutual match, scheduling, offer & payment, performance reporting, or other actions. Each actor 702 may receive a reward 704 (e.g., a percentage based reward, a dynamic reward, etc.) for a given contribution (e.g., action). As an example, company actor 702a may receive a first reward 704a when the company (or another company referred to by the company) is invited to the hiring ecosystem. As another example, the growth partner actor 702b may receive a second award 704b when the company that the growth partner interacts with is onboarded to the hiring ecosystem. Likewise, the growth partner may receive a third reward 704c and a fourth reward 704d when a job is posted or a candidate is submitted for a given job, respectively. Additionally, candidate actor 702c may receive fifth reward 704e when the candidate signs up to the hiring ecosystem.

In some implementations, multiple actors 702 may receive a reward 704 for a given action. For example, during a scheduling offer & placement action (or when such action occurs or is completed), the growth partner actor 702b and the candidate actor 702c may receive sixth reward 704f. In this way, the system enables users (e.g., actors) to receive transparent rewards for each contribution (e.g., action) they make within the hiring ecosystem. It should be noted, that in some implementations, some actions may or may not be associated with a given reward. For example, as shown in FIG. 7, company signup, candidate sourcing, candidate invited, company thumbs up, candidate thumbs up, mutual match, and performance reporting are not associated with a reward 704, although, in other implementations such actions can be.

In some implementations, rewards 704 may be received upon completion of the given action when the given action occurs. For example, where the company actor 702a is invited into the hiring ecosystem, first reward 704a may be automatically triggered to be disbursed to an account associated with the company. In other implementations, rewards 704 may be received upon a candidate being hired. For example, rewards 704a-704f may be automatically triggered at once upon the candidate being hired for a given job posting. Such automatic triggering of the disbursement of reward 704a-704f may be triggered via the smart contract listening for one or more events (e.g., actions) that occur within the hiring ecosystem. In yet other implementations, rewards 704a-704f may be automatically triggered at once upon a verification process indicating that the candidate is hired and currently employed for the given job posting, thereby reducing deceitful actors attempting to obtain funds for incomplete job fulfillment/placement.

### AI Integration

The platform leverages AI agents to automate routine recruiting tasks. The goal is to streamline hiring by removing friction and enabling efficient connections between candidates and hiring managers.

In a given example, the AI core is Perry Assistant, a collection of AI agents powered by Microsoft's AutoGen framework. Other examples such as AutoGPT, OpenAgents, OpenAl, GPTs, BabyAGI, Llama, Mistral, Bard, and other AI agents are similarly suitable. These agents automate key steps in the recruiting workflow—intake, screening, matching, scheduling, negotiations, and more. While AI agents handle the majority of tasks, human involvement is still necessary to handle exceptions and provide guidance.

### Candidate Experience

Conversational interface with Perry for onboarding, job search, and Q&A, Automated profile creation by uploading resumes, Personalized job matches and recommendations, Scheduling assistance for interviews and meetings, Progress tracking throughout funnel, Recruiter/Sourcer Experience, Perry handles screening calls and initial outreach, Calendar management and scheduling coordination, Automated resume/profile parsing, Semantic search for finding qualified candidates, Automated document generation, Natural language querying for recruiting funnel and key analytics.

### Hiring Manager Experience

Conversational Interface for job creation, candidate searches, Customized dashboard to manage open roles and candidates, Automated shortlisting of qualified candidates, Insights from structured resume data, Natural language querying for talent analytics, Auto-scheduling for interviews based on availability, Recruiter Conversations and Handoffs, If candidates or HM have complex questions, Perry can hand-off the conversation to a human recruiter via natural dialog. Recruiters can review conversation history and pick up where Perry left off. Perry learns from recruiter interactions to improve over time.

### AI-Driven Candidate Matching

Perry agents parse job descriptions to extract key requirements using natural language processing. Candidate resumes and profiles are parsed to extract skills, experience, education, and more. Perry uses semantic search and machine learning models to match candidates to open roles based on requirements. Matches are presented to hiring managers for review. Hiring managers can provide feedback on matches to further improve Perry's models.

### Interview Scheduling and Follow-Ups

Once a candidate is selected, Perry reaches out via email and calendar invites to schedule a phone screen or interview. Perry adds scheduled interviews to hiring manager calendars. Automatic reminders are sent before scheduled interviews. Perry sends follow-up emails to candidates with next steps after interviews.

### Offer Negotiation

Based on company guidelines, Perry is empowered to negotiate basic offer terms like salary and start date with candidates directly over email. For exceptions, Perry alerts a human recruiter, who can step in via email or phone. Once terms are agreed upon, Perry generates offer letters for review.

### Analytics and Insights

Perry allows hiring managers to ask questions about recruiting metrics in plain language: “Perry, show me average time to hire for engineering roles last quarter”, “Perry, how many candidates were placed in Seattle offices last year?”, Perry uses natural language processing to transform questions into SQL queries.

Interactive dashboards are generated from PostgreSQL analytics database to answer questions. Verification and Fraud Prevention. Perry agents verify candidate identities using services like ID.me during onboarding. Company emails are validated against public domain records to prevent fake job posts.ML models screen for fraudulent or duplicate profiles and flag them for human review.

### Agent Interaction Flows

We can automate major recruiting workflows using AI agents that collaborate to accomplish tasks. The agents can leverage conversation and personalization capabilities from AutoGen to handle interactions. They can also combine capabilities from MemGPT, models like GPT4, Claude, Cohere, and other large language models to get the jobs done. Some examples of recruiting workflows we could automate are

### Verification Flow

Perry Verifier Agent uses Clear, ID.me and other services to validate user identity and credentials during signup. This prevents fraud. Job Validator Agent checks company email domains, performs web research, and may request HR contact info to verify job legitimacy before posting.

### Job Posting Flow

Job Creator Agent—guides hiring manager through creating a new job post, call an LLM for creation of the Job Description (JD) based on the uploaded data or the questions and answers during the conversation. Job Validator Agent—verifies job post legitimacy (checks company email domains, performs web research, and may request HR contact info to verify job legitimacy before posting). Job SWOT Agent—performs a SWOT on the job using the LLM and RAG to inject context for similar jobs so that the SWOT is grounded. Job Screening Question Agent—based on JD or questions specified by the Hiring Manager, pass the JD to LLM to generate a series of screening questions. Job Interview Question Generate Agent—ask the HM if they'd like us to generate interview questions for part of the pre-screening that they can approve, edit or add to.

Job Validator Agent—This agent would verify the legitimacy of job postings, as described earlier. Job Parser Agent: This agent would extract key details from job descriptions, leveraging functions in the LLM to extract NER data such as skills and requirements, and use LLM to generate a structured representation of the job for future use. Job Embedding Agent: Takes the parsed JD, and converts it to a series of embedding for use in future matching. The following embeddings are generated: Skills embeddings, must-have skills, nice-to-have skills, JD embedding, JD is passed to the Job Summary Agent and when a summary is returned, an embedding is created. All embeddings are stored in a vector store for use by the Matcher, and Recommender Agents in future processes.

Job Summary Agent: Take JD and ask LLM to summarize it. Job FoW Classification Agent: Takes the parsed JD, and leverages the LLM to determine the FoW for the JD. Job Onboarder Agent: This agent would enter structured job data into a database, ensuring that job postings are properly stored and accessible. Job Board Agent: This agent would post jobs to job boards, both internal (Talentpair Branded Custom Job boards) and external, to ensure maximum visibility for job postings.

### Candidate Sourcing Flow

Matcher Agent—identifies and ranks potential candidates for a job. Candidate Finder Agent—searches external databases to source additional candidates. Candidate Screener Agent—evaluates, scores and ranks potential candidates based on job criteria match. Outreach Agent—sends intro messages to candidates to gauge interest

### Candidate Intake Flow

Perry Verifier Agent from Verification flow. Candidate Intake Agent—guides candidate through signing up and creating a profile. Profile Parser Agent—analyzes candidate's resume/background for skills, experience, etc. Profile Writer Agent—assists candidate with optimizing and enhancing their profile. Skill Assessor Agent—can test/verify skills through questionnaires, code samples etc. Profile Coach Agent—provides tips and suggestions to improve candidate's profile and chances of getting hired

### Automated Matching Flow

Job Parser and Resume Parser Agents use LLMs to extract and classify key details from job posts and candidate resumes/profiles. Matcher Agent uses semantic search, keywords, and other signals to automatically suggest potential matches between candidates and open roles. Recommender Agent proactively identifies and suggests candidates that may be a good fit for a new job posting based on previous matches and peer candidates.

### Interview Scheduling Flow

Scheduler Agent—interacts with HM and candidate to find a mutually available time. Calendar Agent—checks availability in calendars and proposes meeting slots. Meeting Confirmation Agent—sends calendar invites once time is agreed upon.

### Offer Process Flow

Offer Generator Agent—creates initial draft of offer letter based on template. Negotiator Agent—discusses salary, benefits, etc with candidate. Offer Finalizer Agent—incorporates negotiated terms and sends final offer. Agreement Manager Agent—facilitates signing of offer letter and manages paperwork

### Analytics Process Flow

Metrics Collector Agent aggregates data on job posts, candidates, hiring performance, user engagement and more. Stores data in Postgres. Natural Language Query Agent allows users to ask questions in plain English (e.g. “How many developer jobs were posted this month?”) and converts to SQL query to generate reports visually. Insights Agent monitors data and proactively surfaces key trends and patterns to users (e.g. Python skills rising in demand).

The Candidate Intake Agent would facilitate the initial signup process and profile creation. The Profile Parser would extract key details to populate the profile. The Profile Writer, Skill Assessor and Profile Coach could all help enhance the candidate's profile to best highlight their abilities and experience.

These agents would provide an automated, personalized onboarding experience for candidates joining the platform. The human-like conversation abilities of AutoGen agents would make the process intuitive and engaging.

Perry is an AI assistant that improves the hiring and onboarding process for companies, candidates, and recruiters. It takes natural language instructions from hiring managers about their open roles. Perry then screens candidates and matches them to suitable positions based on those instructions. It provides a conversational interface for hiring managers, candidates and recruiters to interact with Perry and get updates on the hiring process. Perry also gives natural language access to analytics about the hiring funnel. This allows all parties—companies, candidates, and recruiters—to benefit from Perry's AI capabilities while still maintaining control over the hiring decisions. Below are a few illustrations:

### Candidate Onboarding

Candidate: I'm Alex Johnson, looking to create a talent profile on Talentpair.
Perry Intake: Thanks Alex, let's get you set up. I'll need some basic information like your background, skills, and experience to create your profile. Please upload your resume which I can parse to populate your profile.
Perry Intake: Thanks for providing the details. I've created your initial profile and will continue to enrich it as we interact. Please verify your identity through Clear or ID.me before your profile is live.

### Hiring Manager Search

HM: Perry Assistant, can you help me hire 3 senior Python engineers for my team?
Perry Assistant: Absolutely, I can help automate and streamline your hiring process. To get started, I'll need some details on the role requirements, skills you are looking for, compensation ranges and your hiring timeline. I can then source qualified candidates from the Talentpair network, screen profiles and resumes, schedule interviews for your top picks, negotiate offers for candidates that meet your criteria, and handle all candidate communications and follow ups through the process. Just provide the job specifics and I'll take care of the rest!”
HM: That would be great!Here are the key requirements . . .
PerryAl: “Got it, I'm on it!I'll check back in later today with some recommended candidates for you to review. In the meantime, let me know if you have any other questions!”

### Alternative Conversation

The hiring manager Nancy (HM) logs into the Talentpair platform and asks Perry Assistant:
HM: Perry Assistant, can you find me some candidates for the UI designer opening?
Perry Assistant: Absolutely Nancy. Let me take a look at the job post and candidate database to find some potential matches.
After some time, Perry messages again:
Perry Assistant: I've identified 3 candidates that closely match the requirements for the UI designer role. Their profiles are attached for your review. Let me know if you'd like me to reach out to schedule interviews.
HM (Nancy) reviews the candidates and responds:
HM: These look great Perry. Please move forward with Jane Doe and schedule a phone screen with her next Monday at 2 pm if she's available.
Perry Assistant: Will do!I'll confirm with Jane and add the phone screen to your calendar once scheduled.

### Hiring Manager Analytics

HM: Perry, show me the average time taken to hire for sales roles in Q3 last year
Perry Report: Here is the average time taken to hire for sales roles in Q3 2022:
Account Executive: 29 days
Sales Development Rep: 24 days
Customer Success Manager: 31 days
Let me know if you need any other reports or have additional questions!

### Target Audience

Hiring managers looking to efficiently source and evaluate qualified candidates. Job seekers looking to find suitable opportunities and get recruited. Recruiters seeking a platform to enhance productivity and expand capabilities. Quickly create and match to relevant job opportunities. 24/7 automated screening and scheduling without recruiter back-and-forth. Feedback on profile areas of improvement from Perry agents. Automated candidate screening and scheduling frees up time. Data-driven analytics and reports provide insights for better hiring. NLP interface allows easy access to recruiting analytics. Focus on value-add instead of repetitive tasks. Work collaboratively with Perry agents to fill roles quicker.

By leveraging AI technologies like AutoGen, MemGPT, and other large language models, Talentpair aims to fully automate repetitive recruiting tasks to create more efficient experiences for all users. Our virtual assistant Perry, powered by this AI, handles high-volume tasks like screening and scheduling to find and hire top talent faster. The human oversight enabled by AutoGen's architecture ensures appropriate handling of complex recruiting scenarios. This increased automation allows recruiters to focus on high-value activities like candidate evaluation and negotiation. Overall, PerryAl delivers a frictionless recruiting experience, modular architecture to simplify enhancements over time, and data-driven insights—resulting in better candidate matches, increased efficiency, and informed decisions.

### Model Usage:

Leverage an open source foundation model or OpenAl that we fine tune. Benefit of hosting the model or using a 3rd party provider of a foundational model, that we can fine tune, is that we are in control of availability, scalability, and reliability of the platform. Currently when using a service offering like OpenAl we have limited control and need to account for the constant outages and issues they are experiencing due to growth. Downside to hosting and fine tuning is the cost, it may be better to leverage a service like AWS Bedrock or HugginFace or other providers to host the model and we just fine tune it. Our existing models and the data set(s) become elements of the fine tuning of the foundational model to make it Talent Acquisition focused. Data extraction, classification, enhanced matching and more are all byproducts of this approach.

Matching is enhanced by the following: Enable Company specific criteria as part of matching, Let the company define scores for given attributes that are important to them for a given field of work (FoW),This would get injected into the prompt that is used in the final stage of matching to score candidates to job(s), Perform hybrid search leveraging both Semantic/Similarity and keyword searches with a level of fuzziness and target for keyword searches. Once this set of matches is created for the job, the top N are run through the fine-tuned foundation model and scored based on our predefined standard+the overrides provided for a given job by the HM/Client from above. Top N results are provided for contact

Job Classification (FoW)—Use LLM to provide job, talent, seniority, and other classifiers for Talentpair. For example, pass a job into LLM with appropriate prompt and a list of FoW's having it classify the job based on that list. One could also use a similar approach to have it predict the FoW if it is not one we currently have and get it added to the platform. Other Classifiers: Seniority, Company (Startup, Internal Incubator, growth, mature . . . ), Recruiter (specialities), Candidate (specialization, specialties).

Parsing: Utilizing LLM and NER to parse both a resume and job descriptions similar to any modern ATS. This step is crucial as it converts the documents into a format that the system can effectively analyze and match.

Keyword Extraction: LLM facilitates this advanced machine learning algorithm that we employ in Talentpair to extract the most pertinent keywords from the job description. These keywords represent the desired skills, qualifications, and experiences of the employer/candidate.

Key Terms Extraction: In addition to keyword extraction, the tool utilizes spacy-Ilm and other libraries to identify the main key terms or themes in the job description or resume. This step aids in comprehending the broader context of the content in the resume.

Vector Similarity Using pg-vector: Talentpair utilizes pg-vector, an efficient vector similarity search tool, to gauge the degree of similarity between a resume and the job description. In addition, since this is an extension to Postgres, we can apply other filters around key words and other attributes to achieve a hybrid search. This process involves representing your resume and job description as vectors in a high-dimensional space and calculating their cosine similarity. The higher the similarity, the greater the likelihood of a resume successfully passing matches a JD. Adding the hybrid features increases the matching accuracy. Matching/Scoring Resume against Job. Recommending training for missing skills or experience. Sentiment Analysis

Candidate resumes are implemented with JSON schema that are then used for scoring and recommendations. Basic prompt would look something like this and would be a two pass process. First pass gets it into the jsonresume schema format, second pass scores the resume providing recommendation for each section. For example, results would look something like this:

```
{
  “score”: “8.5”,
  “detailed_review”: [
    {
      “section”: “Education Details”,
      “score”: “8”,
      “comments”: “The candidate has a Master of Business Administration degree and a
Bachelor of Science in Information Systems Management. The education details are
relevant to the industry and demonstrate a strong foundation in business and technology.”
    },
    {
      “section”: “Summary & Objective”,
      “score”: “9”,
      “comments”: “The summary and objective section effectively communicates the
candidate's experience, skills, and goals. It highlights their expertise in technology
leadership, architecture, and product management.”
    },
    {
      “section”: “Skills & Work Experience”,
      “score”: “8”,
      “comments”: “The candidate has a diverse range of technical skills and extensive work
experience in various roles, including Vice President of Engineering and Data Science,
CEO/Owner of a software consulting firm, and Director-level positions. The skills and work
experience align with the job opportunities they are seeking.”
    },
    {
      “section”: “Contact Details”,
      “score”: “9”,
      “comments”: “The resume includes the candidate's name, email-id, address, mobile
number, and Linkedin profile. All the necessary contact details are provided.”
    },
    {
      “section”: “Resume Action Verbs”,
      “score”: “8”,
      “comments”: “The resume includes strong action verbs and demonstrates the
candidate's impact-oriented approach. However, there is room for improvement in terms of
using more specific and quantifiable achievements.”
    }
  ],
  “detailed_suggestions”: [
    {
      “section”: “Education Details”,
      “suggestions”: [
        “Include the year of graduation for each degree.”
      ]
    },
    {
      “section”: “Skills & Work Experience”,
      “suggestions”: [
        “Provide more specific and quantifiable achievements for each work experience.”,
        “Highlight any leadership or team management experience in the work experience
section.”
      ]
    },
    {
      “section”: “Resume Action Verbs”,
      “suggestions”: [
        “Use more specific and impactful action verbs to describe achievements and
responsibilities.”
      ]
    }
  ],
  “improvements”: [
    “Include the year of graduation for each degree.”,
    “Provide more specific and quantifiable achievements for each work experience.”,
    “Highlight any leadership or team management experience in the work experience
section.”,
    “Use more specific and impactful action verbs to describe achievements and
responsibilities.”
= ]
}
```

### Smart Contracts

Talentpair leverages the concept of a set of Smart Contracts to ensure that there are fair, equitable and transparent payouts to all contributors to a placement of a candidate. This can be any one of the 3 core actors (Candidate, Hiring Manager, or Recruiter) as well as Perry. There are two smart contracts associated with a Job. Job: Since a Job can have 1..n openings to be filled, there is one Smart Contract tied to the Job Opening: Each opening has a smart contract tied to it, that handles the commission split for that opening. When an opening is filled the job reflects the number of renaming openings, and a pointer to the opening that was filled for the job is stored in the Job's smart contract. When an opening is filled, the commission split logic kicks off and the buckets are allocated per contributor. This is stored in an immutable ledger for reference purposes. Upon the end of the guaranteed period the payout step is triggered on the smart contract fires and funds are disbursed to the contributors of the opening. Any time after the commission split executes and prior to the disbursement of funds, the data is available for viewing by all Actors via their dashboard to see pending payouts. After the disbursement the payout is no longer pending, but data is still available for viewing to see one's earnings. Once all openings are filled the job goes to a closed state. All interactions are stored and maintained in an immutable ledger, today this is off chain.

### System Architecture

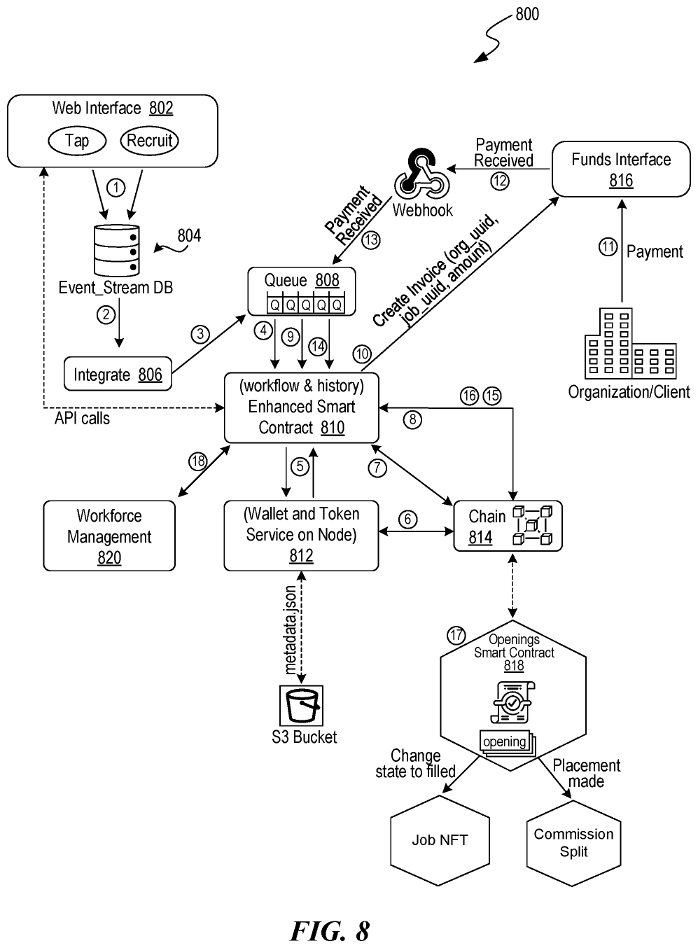

FIG. 8 shows a system architecture of the disclosed system, in accordance with some implementations of the present technology. For example, FIG. 8 shows an example architecture for providing transparent action based rewards via decentralized computing network triggers.

To provide an optimized method of automatically disbursing rewards for given actions, system architecture 800 can use various components interacting with one another to transparently disburse rewards to respective actors for their respective contributions (e.g., actions). For instance, existing systems may only currently pay recruiters for their respective interaction with a given system/platform/or candidate, leaving no room for other actors to receive rewards for their contributions. Moreover, payment to the recruiters may be effectuated based on another human user (e.g., system administrator) simply monitoring for the recruiters indication that he/she interacted with a job candidate, thereby providing the funds to the recruiter alone based on an unverified placement of the job candidate. Due to the manual review of the recruiter's contribution, which may be based on the mere opinion of the one verifying the contribution, the amount of time to which actors may receive rewards for a given contribution is increased and may lack transparency. Due to the lack of transparency, users are often driven away from the platform altogether as each user must trust the system administrators to distribute the funds properly and equally.

On the other hand, by utilizing the system architecture shown in FIG. 8, the system may provide an optimized, automatic, flow of creating invoices, recording each contributor and their respective actions, and disbursing rewards in a transparent methodology leveraging blockchain and WEB3 approaches. For example, as each actor, action, and respective rewards are published on the public blockchain, users of the system may verify that such rewards are being disbursed fairly (e.g., equally) for each user of the system, thereby foregoing the opinion of system administrators currently found in existing systems. Moreover, as each action occurs, due to the nature of the blockchain requiring gas (e.g., gas fees) to perform one or more blockchain related functions (e.g., read, writes, mints, contract execution), funds (e.g., ether) may be obtained from a respective actors wallet/account (e.g., digital wallet) to “fund” a respective transaction/action on the blockchain, thereby discouraging deceitful users from interacting with the hiring architecture. Additionally, by optimizing the methodology with respect to the automatic disbursement of rewards for given contributions (e.g., actions), network traffic may be reduced as the smart contract(s) stored on the blockchain can listen for certain events, forgoing the multitude of status requests for completion of each task, verification requests of each task, and reward release requests transmitted over computing networks (e.g., the Internet), as seen in existing systems. Moreover, as opposed to existing systems, contributions of all actors may be accounted for and rewarded appropriately, thereby mitigating a sole actor from reaping all rewards for other's contributions.

To effectuate such benefits, the components of system architecture 800 may be used. For instance, web interface 802, event stream 804, integrate 806, queue 808, enhanced smart contract 810, wallet service 812, chain 814, funds interface 816, openings smart contract 818, workforce management 820, or other components may be utilized within the system architecture 800. Web interface 802 can be a website, webpage, or other user interface configured for enabling users (e.g., actors, biotic actors, etc.) to interact with the hiring ecosystem. As an example, a user may use one or more user devices (e.g., mobile device, fixed terminal devices, laptop, desktop, smartphone, wearable device, etc.) to access the hiring ecosystem, to perform one or more actions with respect to the hiring ecosystem, or other operations. Event stream 804 can be a database (or other data structure) configured to record given events of the system, such as events received from web interface 802. Integrate 806 can be a service that is an open-source platform (e.g., Airbyte) configured to integrate data from one component to another component, such as from event stream 804 to queue 808. Queue 808 can be a queue (e.g., or other data structure such as a first in first out, first in last out) that prepares events to be disbursed from one component to another component. Enhanced smart contract 810 can be a smart contract, as described above, to governs the hiring ecosystem. Additionally or alternatively, enhanced smart contract 810 may be a smart contract that determines a given workflow for a given event within the hiring ecosystem. For example, where a job creation event is received by queue 808, enhanced smart contract 810 may determine the given action (e.g., job creation) and determine the next action to be effectuated.

Wallet service 812 can be a wallet service that is configured to create or interact with one or more digital asset wallets and invoke smart contract related actions (e.g., Watson). For example, the digital asset wallets may be a hot wallet (e.g., connected to the Internet) or a cold wallet (not connected to the Internet). Chain 814 can be a blockchain to which the hiring ecosystem is built upon. For example, Chain 814 may be the Ethereum blockchain (or Ethereum based-blockchain such as Flare) that includes one or more actor profiles, NFTs, resumes, qualifications, certifications, verification statuses, smart contracts, or other information, in accordance with one or more implementations of the present technology. Funds interface 816 can be any service/interface configured to generate invoices, transactions, reports, or other financial related operations (e.g., Quickbooks), in accordance with one or more implementations of the present technology. Openings smart contract 818 can be a smart contract configured to trigger the automatic disbursement of rewards, in accordance with one or more implementations of the present technology. For example, smart contract 818 may live on chain 814 and may monitor for one or more actions, at the right time, by the right actor to trigger the disbursement of respective rewards to respective actors. Workforce management 820, can be a workforce management service, such as Ripple, that may perform one or more administrative tasks with regard to a given company (e.g., a company related to the hiring ecosystem).

With respect to FIG. 8, web interface 802 may transmit events to event stream 804. In some implementations, the events may represent the actions as discussed above. For example, for a job creation event, event stream 804 may receive the job creation event. Event stream 804 may store the event (e.g., job creation event, job creation action) in a database associated with the event stream. For example, the event stream 804 may store the event and event related data (e.g., actor identifier, organization universal identifier, job universal identifier, hash value, job state, token universal uniform resource locator, user identifiers, the action, verification status, etc.) in the database associated with the event stream, such as in a table, graph, array, dictionary, or other data structure.

Integrate 806 may read the database (e.g., from event stream 804) and may determine event-related information to send to queue 808. For instance, the event-related information may include the event or the event related data for the given event/action. To ensure that rewards may be distributed to the appropriate actor effectuating the given event/action, the system may ensure that the given actor is associated with a wallet for receiving the funds. As such, queue 808 may interact with enhanced smart contract 810 to transmit information related to the actor, such as the actor's identifier from the event-related data, to wallet service 812. Wallet service 812 may determine whether a wallet is associated with the given actor. In response to wallet service 812 determining that there is not a wallet currently associated with the given actor, wallet service 812 may create a new wallet for the actor (e.g., via a blockchain-related wallet application, a hot wallet application, a cold wallet, or other wallet creation mechanism). As an example, the new wallet may be a custodial wallet (e.g., a wallet as hosted by the wallet service 812) to enable user to avoid unnecessary transaction fees when performing one or more actions. In some implementations wallet service 812 may be configured to generate a NFT including the event-related information. For instance, each job posting (as well as actors themselves) may each be associated with an NFT that describes the action or actor themselves. In the context of a job posting, in order to maintain transparency and ensure that job requirements are not changed for the given job, an NFT may be minted to enable all actors of the system to view the various requirements for the job posting. For example, the job posting, when minted as an NFT, may include immutable data (e.g., a job identifier identifying the verified job posting, hash value, etc.) and mutable data (e.g., URI pointing to job details description). As the job is minted as an NFT and includes immutable data (e.g., due to the nature of the blockchain and the NFT), the information included in the NFT may not change, thereby preventing nefarious users/actors from altering job posting related information. Furthermore, as the NFT includes mutable data, such as metadata, certain aspects of the NFT may be updated, such as the job details description, thereby forgoing reminting of a job posting when one or more errors may exist within the job posting details. In this way, the system may reduce the amount of computer processing and memory resources utilized when minting a new NFT.

Upon the NFT being minted (e.g., created), the NFT may be stored on chain 814 thereby enabling users to view information related to the NFT. In this example, where the NFT represents a job posting, actors of the system are enabled to view the job posting. For example, by accessing a URI to an off-chain location hosting the job details information, users may access details of the given job posting. Additionally, by storing the job details information off-chain as opposed to on-chain, the cost associated with minting the NFT (e.g., due to gas fees), may be reduced as there exists a direct correlation between the amount of data stored on chain and gas fees required to verify a given action/transaction.

Enhanced smart contract 810 may monitor for one or more events. For instance, as discussed above, smart contracts may include one or more listening functions/methods such that when a given action occurs, corresponding functions/methods may automatically execute. In the context of when a candidate applies to a job, the enhanced smart contract 810 may execute one or more functions to store and/or automatically distribute one or more awards for respective actors.

Referring back to FIG. 7, upon a candidate sign up (e.g., signing up for the hiring ecosystem, signing up for a given job, etc.), the enhanced smart contract 810 may be invoked to store and/or automatically distribute fifth reward 704e. For instance, as discussed above, in some implementations, rewards may be automatically distributed to appropriate actors when the action is invoked. In other implementations, rewards may be automatically distributed to appropriate actors when a job placement event occurs, indicating an end of the job cycle. In the case of where rewards are automatically distributed when the job placement event occurs, due to other actions that may have had occurred prior to a job placement (e.g., company sign up, company verification, job posting, candidate signup, job send, etc.), enhanced smart contract may store which actors (e.g., via actor identifier), which actions the actor has contributed, and the corresponding reward amount (e.g., percentage amount, fixed amount, etc.), in a database (e.g., on chain, off chain, etc.) for retrieval when a job placement event occurs. In this way, all actor's contributions are accounted for and upon a job placement event occurring, all actors who have contributed to the given job placement event may be automatically provided with the appropriate rewards.

For example, referring back to FIG. 8, upon a job placement event (e.g. action), enhanced smart contract 810 may detect that a candidate has been placed for a given job posting. Such job placement event may include placement event-related data, such as actor identifier, organization universal identifier, job universal identifier, hash value, job state, token universal uniform resource locator, user identifiers, the action, verification status, or other information. The enhanced smart contract 810 may listen for such an event, and in some implementations, queue 808 may provide the smart contract with the job placement event-related data (e.g., that may be obtained from web interface 802). The enhanced smart contract 810 may determine from the job placement event-related data which contributors (e.g., actors) and contributions (e.g., actions) that were performed that lead to the job placement of a given candidate. The enhanced smart contract 810 may add the contributors and contributions to the smart contract 818 to begin automatically disbursing respective rewards for each actor for their respective contributions to the job placement.

Upon determining the contributors and the contributions, the enhanced smart contract 810 may provide the placement event-related data to funds interface 816 to generate an invoice for each contributor based on their respective contributions. For example, the invoice generated by funds interface 816 may include the organization universal identifier, job universal identifier, placement identifier (e.g. an identifier indicating which actor has been placed at the job, which actors contributed to placing the actor to the job, the contributions for each actor who contributing, a combination thereof, an identifier indicating an address to off-chain information including respective actors and their respective contributions for a given event, etc.). Funds interface 816 may then interact with the enhanced smart contract 810 to update smart contract 818 with a status that the invoice has been generated (e.g., payments received status) to enable the smart contract 818 to properly distribute the respective rewards for each contributor for their contribution(s). For example, upon a job placement event (e.g., indicating that a candidate has been placed to a job), funds interface 816 may invoke smart contract 818 to distribute funds from a client (e.g., an agency, company, etc.) to each respective actor according to their contributions for the job placement event.

Smart contract 818 may then be invoked to record (e.g., create, store, etc.) the rewards on chain 814. As an example, smart contract 818 may invoke a recordCommmisionSplit method included within the smart contract using the placement identifier. When the recordCommissionSplit method is invoked, a commissionSplitEvent is emitted (e.g., a method indicating to disburse respective rewards for contributions), and contributor(s) addresses (e.g., wallet addresses), the action, and the reward (e.g., reward amount) to alert nodes within the hiring ecosystem that a job placement event has occurred. As such, all users (e.g., nodes, actors, etc.) of the system may be notified of a given job being filled.

The enhanced smart contract 810 can then listen for the emitted event (e.g., the commissionSplitEvent) and can generate off chain reward entries into a payroll for contributors. For example, the enhanced smart contract 810 may provide information to funds interface 816 (and/or workforce management 820) to provide such rewards via an invoice to the respective actors for their contributions for the job placement. As an example, the enhanced smart contract may invoke a disburseCash method to determine contributions of the contributors, the reward amounts for each contributors contributions, and the contributors address, to add up the reward amounts (e.g., a sum of each contribution of the contributor) and automatically distribute the reward amount(s) to the respective contributor. Additionally or alternatively, as the smart contract 818 may automatically distribute the appropriate rewards to each contributor for their contributions (e.g., by providing such rewards to contributor(s) addresses).

In some implementations, upon the commissionSplitEvent being emitted, the enhanced smart contract 810 may update the job posting NFT. For example, the enhanced smart contract 810 may update metadata associated with the job posting NFT to change the status of the job posting (e.g., indicating that the job/position has been filled, closed, etc.). In some implementations, the enhanced smart contract 810 may update the NFT when all contributors have been rewarded for their respective contributions in filling the job posting. As such, the system ensures respective contributors have all been awarded prior to closing a given job posting. Additionally, the system also ensures that once a job has been filled, the NFT is automatically updated, thereby preventing other actors from applying to the job (and other contributors from receiving misappropriated rewards for filling/recommending candidates to a closed/filled job). Lastly, as the NFT is stored on chain, is public, and is transparent, users (e.g., actors of the hiring ecosystem) are enabled to view when certain jobs are filled, which contributors may have contributed to the job placement, and the rewards associated with such job placement, thereby further maintaining transparency within the hiring ecosystem.

In some implementations, rewards may be distributed in perpetuity. For example, a benefit to storing actions (e.g., contributions) that actors (e.g., contributors) perform within the hiring ecosystem on a blockchain, is that such actions are “permanent” on the blockchain. This enables actors to be rewarded in perpetuity as there is no centralized administrator to deny an actor rewards (e.g., as rewards are automatically distributed via the smart contract). For example, where a growth partner actor recruits a company that hires 500 candidates over a span of 1 year, such growth partner may receive rewards for each time a candidate is connected to the particular company. As the smart contract emits events (e.g., when a candidate is placed into a job, or for other actions), the hiring ecosystem remains transparent. Such events are then recorded onto the blockchain with the event related data, which may include information related to the actor that recruited the company for which the candidate was hired onto. Thus, the actor that recruited the company may receive an award for their contribution (e.g., of recruiting the company) each time a job is fulfilled/placed.

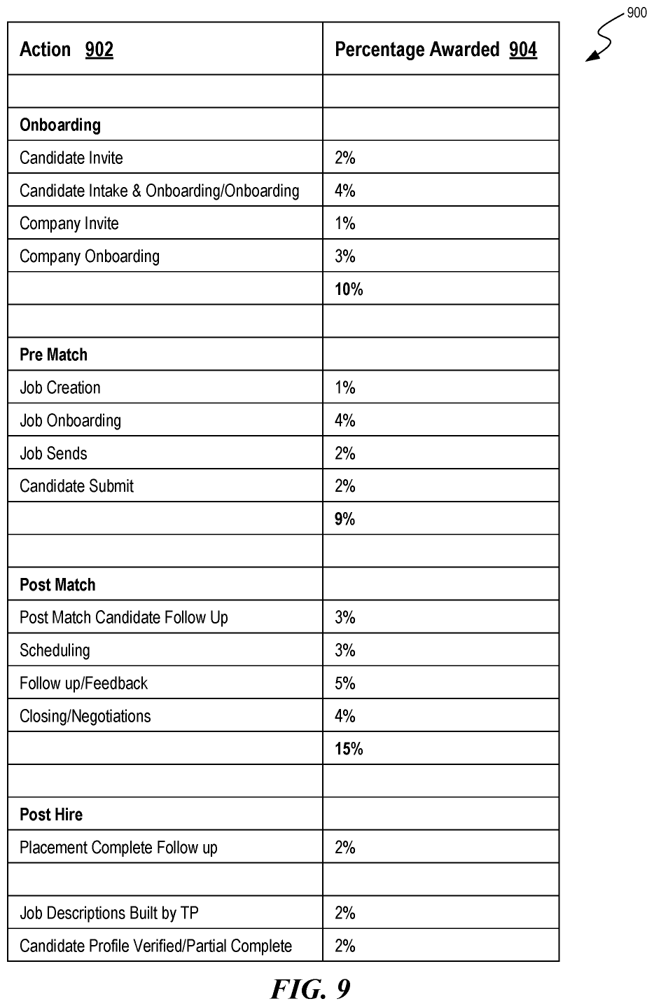

FIG. 9 shows an illustrative table indicating actions and contribution percentages, in accordance with some implementations of the present technology. For example, as each contribution (e.g., action 902) may be associated with a respective reward 904, when the commisionSplitEvent is invoked by the enhanced smart contract 810, the enhanced smart contract 810 may use table 900 to determine which rewards should be disbursed to respective actors based on their contributions. It should be noted, that although certain percentage awards are shown as rewards 904, that other percentages, amounts, or metrics for determining such rewards corresponding to contributions (e.g., action(s) 902) may exist and are not limited to the percentages/awards shown in table 900.

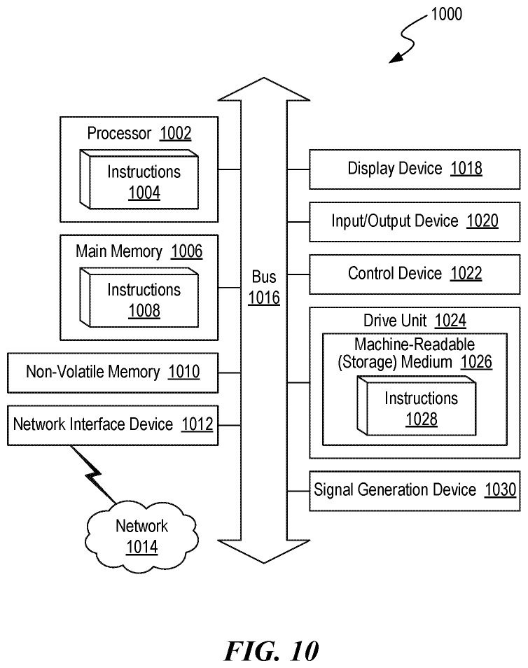

FIG. 10 shows a block diagram illustrating an example of a processing system in which at least some operations described herein can be implemented. As shown, the computer system 1000 can include: one or more processors 1002, main memory 1006, instructions 1008, non-volatile memory 1010, a network interface device 1012, display device 1018, an input/output device 1020, a control device 1022 (e.g., keyboard and pointing device), a drive unit 1024 that includes a storage medium 1026 and instructions 1028, and a signal generation device 1030 that are communicatively connected to a bus 1016. The bus 1016 represents one or more physical buses and/or point-to-point connections that are connected by appropriate bridges, adapters, or controllers. Various common components (e.g., cache memory) are omitted from FIG. 10 for brevity. Instead, the computer system 1000 is intended to illustrate a hardware device on which components illustrated or described relative to the examples of the figures and any other components described in this specification can be implemented.

The computer system 1000 can take any suitable physical form. For example, the computer system 1000 can share a similar architecture to that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computer system 1000. In some implementations, the computer system 1000 can be an embedded computer system, a system-on-chip (SOC), a single-board computer system (SBC) or a distributed system such as a mesh of computer systems or include one or more cloud components in one or more networks. Where appropriate, one or more computer systems 1000 can perform operations in real-time, near real-time, or in batch mode.

The network interface device 1012 enables the computer system 1000 to exchange data in a network 1014 with an entity that is external to the computing system 1000 through any communication protocol supported by the computer system 1000 and the external entity. Examples of the network interface device 1012 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 1006, non-volatile memory 1010, machine-readable medium 1026) can be local, remote, or distributed. Although shown as a single medium, the machine-readable medium 1026 can include multiple media (e.g., a centralized/distributed database and/or associated caches and servers) that store one or more sets of instructions 1028. The machine-readable (storage) medium 1026 can include any medium that is capable of storing, encoding, or carrying a set of instructions for execution by the computer system 1000. The machine-readable medium 1026 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 1010, removable memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1004, 1008, 1028) set at various times in various memory and storage devices in computing device(s). When read and executed by the processor 1002, the instruction(s) cause the computer system 1000 to perform operations to execute elements involving the various aspects of the disclosure.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations can perform routines having steps, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples: alternative implementations can employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, specific terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

We claim:

1. A method comprising:
providing a user interface that corresponds with an artificial intelligence (AI) agent, wherein output of the AI agent as guided by a user via the user interface is passed to a blockchain agent, and wherein output of the AI agent sorts user input into categories defined by a smart contract; and
providing the smart contract registered on a blockchain data structure that receives output of an AI agent from a blockchain agent, wherein the smart contract logs data as sorted by the AI agent to predetermined categories established by the smart contract.

2. A system as that executes the method of claim 1.

3. A non-transitory computer readable medium storing instructions, which when executed by at least one computing device, perform the method of claim 1.
